(19) United States
(12) Patent Application Publication
(10) Pub. No.: US 2013/0323432 A1
(43) Pub. Date: Dec. 5, 2013

(54) COMPOSITION FOR PRINTING TACTILE FEATURES ON A SECURITY DOCUMENT

(71) Applicant: Canadian Bank Note Company, Limited, Ottawa (CA)

(72) Inventors: Tadeusz Piotr RYGAS, Ottawa (CA); Thivaharan THURAILINGAM, Kanata (CA); Silviu CRISAN, Gatineau (CA); Norbert Joseph Sylvain CHALIFOUX, Cantley (CA)

(73) Assignee: Canadian Bank Note Company, Limited, Ottawa (CA)

(21) Appl. No.: 13/905,469

(22) Filed: May 30, 2013

Related U.S. Application Data
(63) Continuation-in-part of application No. 13/131,781, filed on Jun. 17, 2011.

(30) Foreign Application Priority Data
Dec. 22, 2008 (CA) PCT/CA2008/002240

(51) Int. Cl. C09D 11/02

(52) U.S. Cl. CPC C09D 11/03
USPC 427/511

(57) ABSTRACT

Improved ultraviolet light-curable compositions are provided for printing onto a security document substrate in a predetermined pattern to make tactile features for use by people with impaired vision to, for example, recognize the denominations of banknotes. The improved compositions substantially comprise an acidic trifunctional acrylate ester, preferably in an amount of 60-80 wt %, and include urethane acrylate and effective amounts of flexibilizer (e.g. low viscosity aromatic monoacrylate having an elongation parameter of about 200), photoinitiator and a rheological additive (e.g. silica). The composition unexpectedly provides flexibility and is particular useful for printing tactile features in the form of relatively large continuous graphical patterns.

### RELATED APPLICATIONS

This application is a continuation-in-part application of U.S. application Ser. No. 13/131,781, which is a national stage filing under section 371 of International Application No. PCT/CA2009/001869, filed on Dec. 21, 2009, and published in English on Jul. 1, 2010 as WO 2010/071993, and claims priority to PCT application No. PCT/CA2008/002240 filed on Dec. 22, 2008. The entire disclosures of these applications are hereby incorporated herein by reference.

### FIELD OF THE INVENTION

The invention relates to the field of security printing compositions and, more particularly, to improved compositions for use in printing onto security documents (e.g. banknotes) tactile features for use by the visually impaired to distinguish the type or form of the document (e.g. the denomination of a banknote).

### BACKGROUND

There is a need and desire to incorporate physical features into products handled by visually impaired people so that they can discern certain characteristics relating to such products. For example, it is important that visually impaired people be able to distinguish and use products such as security documents in correct manner. In the case of banknotes, in particular, there is a need to be able to distinguish between different denominations of banknotes by feeling the banknote surfaces. For this purpose, currency-issuing national banks seek to incorporate a tactile feature in their production of banknotes.

Examples of discernible features that are in use in the marketplace include varying the size of banknotes for different denominations, and applying tactile features by embossing the banknotes, for example using deep intaglio-printed patterns, or printing onto the banknotes tactile marks, formed as a group of small Braille-like raised areas (bumps) in the shape of dots, bars, ovals, stars or triangles which, together, can be easily felt and discerned to distinguish the type of document by the user feeling the surface of the document in the areas which have been so printed. However, in order to be effective and acceptable for use in the security printing industry, the composition to be used to print such tactile features onto a banknote substrate must produce markings which have both a durable tactility, meaning that they must not flatten or wear down too quickly, and durable integrity, meaning that they must not break off, crack or otherwise become damaged in manner which impairs their tactile functionality over a desired lifetime for the security document.

The previously known and used compositions for printing tactile features such as Braille-like marks were found to lack durability in one or both of tactility and integrity, because they could provide only tactile marks that would too quickly become flattened over a period of use so as to become less tactile or too easily become broken off or torn from the substrate on which they were printed, or both. The applicant developed the new composition, as described in said parent application Ser. No. 13/131,781, for printing tactile marks onto a substrate of a security document which demonstrated improved durability over that provided by previously known compositions. Of particular advantage, it was found that the composition of said parent application could be used to print tactile marks having sufficient rigidity to be calendered between the plates of an intaglio printing press (i.e. pressed under high pressure) to force the tactile marks into the substrate and render them tactile from both sides of the security document (this process having been described in the applicant's related PCT application no. PCT/CA2008/002240 published under no. WO/2010/071956.

The durability of tactile features is assessed on the basis of one of more of a number of different types of tests, depending upon the particular size and form of the tactile feature and the type of security document involved. Generally, the better the test results obtained, the better will be the level of quality of the tactile feature since an improved durability (whether for tactility and/or integrity) is a desirable characteristic for a tactile feature of a security document.

### SUMMARY OF THE INVENTION

In accordance with the present invention a method is provided for making a tactile feature for use by the visually impaired on a substrate of a security document. An ultraviolet light curable printable composition is printed onto the substrate in a predetermined pattern, wherein the composition substantially comprises an acidic trifunctional acrylate ester. The printed composition is exposed to ultraviolet light to cure the printed composition and form the tactile feature on the substrate, wherein the tactile feature has an easy-to-feel tactility to enable a person who is visually impaired to distinguish the security document.

The composition comprises an amount of 30-85 wt % of acidic trifunctional acrylate ester and, more preferably, an amount of 60-80 wt % of acidic trifunctional acrylate ester, and further comprises effective amounts of flexibilizer (e.g. low viscosity monoacrylate having an elongation parameter within a range of 100 to 400, in an amount of about 3-9 wt %), urethane acrylate (e.g. in the range of about 4-28 wt %), photoinitiator and a rheological additive (e.g. silica).

The tactile feature may be a continuous graphical pattern having a width and length in the range of 5 to 50 mm or may be a pattern of discrete marks in the form of dots having a diameter of 1 mm or less, or bars, ovals, stars or other shape having a width and length in the range of 0.1 to 5 mm.

### BRIEF DESCRIPTION OF THE DRAWINGS

Embodiments of the invention are described with reference to the following drawings in which like reference numerals refer to like elements throughout.

FIG. 1 is a profile view of a banknote printed with a first exemplary tactile feature (30) comprising a Braille-like pattern of twelve discrete tactile marks (40) arranged in two groups of six tactile marks (40) each, wherein the tactile marks (40) were printed using a tactile print composition in accordance with the present invention.

FIG. 2 is a profile view of a banknote printed with a second exemplary tactile feature (30) forming the number “20”, wherein the tactile feature (30) comprises two larger continuous tactile graphical patterns (50), one forming the numeral “2” and the other forming the numeral “0”, printed using a tactile print composition in accordance with the present invention.

FIG. 3 is a block diagram illustration of an exemplary method using a silkscreen process for printing a tactile print composition in accordance with the present invention onto a security document such as the banknote of FIGS. 1 and 2 to form a tactile feature.

FIG. 4 is a schematic cross-sectional view of the banknote of FIG. 2 showing one of the tactile graphical patterns (50) of the tactile feature (30) printed onto the banknote substrate (20).

FIG. 5 is a schematic cross-sectional view of a banknote having a tactile feature in the form of a tactile graphical pattern (50) similar to that of FIG. 2 printed onto the banknote substrate (20) but having a grit component (60) added to the tactile print composition.

### DETAILED DESCRIPTION

The composition of applicant's said parent application Ser. No. 13/131,781 provides a rigidity to the tactile marks which is particularly desirable for applications in which the tactile marks are to be calendered as described in the related PCT application no. PCT/CA2008/002240 published under no. WO/2010/071956. However, that characteristic of rigidity may be undesirable for printing onto a banknote a tactile feature in the form of a continuous graphical pattern over a relatively large area of the substrate; through experimental investigation, applicant has found that as the print coverage area increases it is desirable for the tactile print composition to provide the opposite characteristic, namely, that of flexibility rather than rigidity.

A new, inventive curable tactile print composition for printing a tactile feature onto a security document substrate has been developed by the applicant after detecting a surprising effect of a constituent of the composition and completing a series of experimental testing for purposes of investigating that effect. More specifically, it was unexpectedly discovered that an adhesion additive, viz. a trifunctional acid acrylate ester (Sartomer product SR-9053), used in the composition of applicant's said parent application Ser. No. 13/131,781 to increase the strength of the substrate-penetration-related anchoring of the composition, interacts with the other particular constituents of the composition in a manner which achieves the opposite effect to the rigidity of the composition of said parent application Ser. No. 13/131,781 and normally associated with trifunctional acrylates due to their high degree of cross-linking polymerization.

Through experimental testing this surprising result was confirmed and it was found that a composition substantially comprising an acidic trifunctional acrylate ester, as the primary and predominant constituent, provides, when printed, good flexibility rather than rigidity and improved durability of tactility and integrity.

Contrary to the amounts normally associated with an additive-type constituent, and the small additive-type amounts recommended by the manufacturer (Sartomer) of the additive), it was found that even an amount of 85 wt % of the acidic trifunctional acrylate ester, in combination with relatively small amounts of a flexibilizer, urethane acrylate and curing and rheological additives (i.e. photoinitiator and silica, resp.) produced a curable tactile print composition which makes tactile features having good durability. In particular, this new curable tactile print composition (hereinafter referred to as the “new” or “present” composition) was found to produce a tactile feature having particularly good flexibility and durability when used to print a relatively large continuous graphical pattern such as that shown by FIG. 2.

The applicant conducted a series of comparative tests, as follows, to compare durability test results for tactile features printed using the composition of said parent application Ser. No. 13/131,781 to test results obtained for tactile features printed using the new composition which substantially comprises an acidic trifunctional acrylate ester (product SR-9053 of Sartomer) as the predominant constituent. The composition used according to said parent application Ser. No. 13/131,781 is detailed in Table 1 below. The new compositions, in accordance with the present invention, used for this testing had much higher concentrations, namely, one having 60 wt % and another having 85 wt %, of the acidic trifunctional acrylate ester (product SR-9053 of Sartomer) as detailed in Table 2 below.

As indicated, the main differences between the composition of Table 1 and the new compositions of Table 2 are in the concentration of acidic trifunctional acrylate ester (SR-9053). The comparative testing was carried out by printing the compositions of Tables 1 and 2 onto banknote paper.

TABLE 1

| Component/Function | Product | Wt. % | Weight, g |
|---|---|---|---|
| Low viscosity acrylate | Cognis Photomer 4127 | 50.93 | 101.70 |
| Urethane acrylate | CN-9009 | 20.48 | 40.90 |
| Reactive diluents | SR-9020 HP | 8.61 | 17.20 |
| Photoinitiator | Esacure-KS 300 | 3.15 | 6.30 |
| Photoinitiator | Esacure TZT | 2.30 | 4.60 |
| Trifunctional acid ester | SR-9053 | 12.52 | 25.00 |
| Rheological additive (silica) | Aerosil 200 | 2.00 | 4.00 |
| Total: | | 100.00 | 199.70 |

TABLE 2

| | 60 wt-% | 85 wt-% |
|---|---|---|
| | SR-9095 | SR-9095 |
| COMPONENT PRODUCT | wt. % | wt. % |
| Flexibilizer -CN 131 | 7.00 | 2.95 |
| Urethane acrylate - CN-9009 | 25.00 | 3.94 |
| Photoinitiator - Irgacure 2100 | 3.00 | 2.95 |
| Photoinitiator - Irgacure 184 | 3.00 | 2.95 |
| Trifunctional acid ester - SR-9053 | 60.00 | 85.24 |
| Rheological additive - Aerosil 200 | 2.00 | 1.97 |
| Total: | 100.00 | 100.00 |

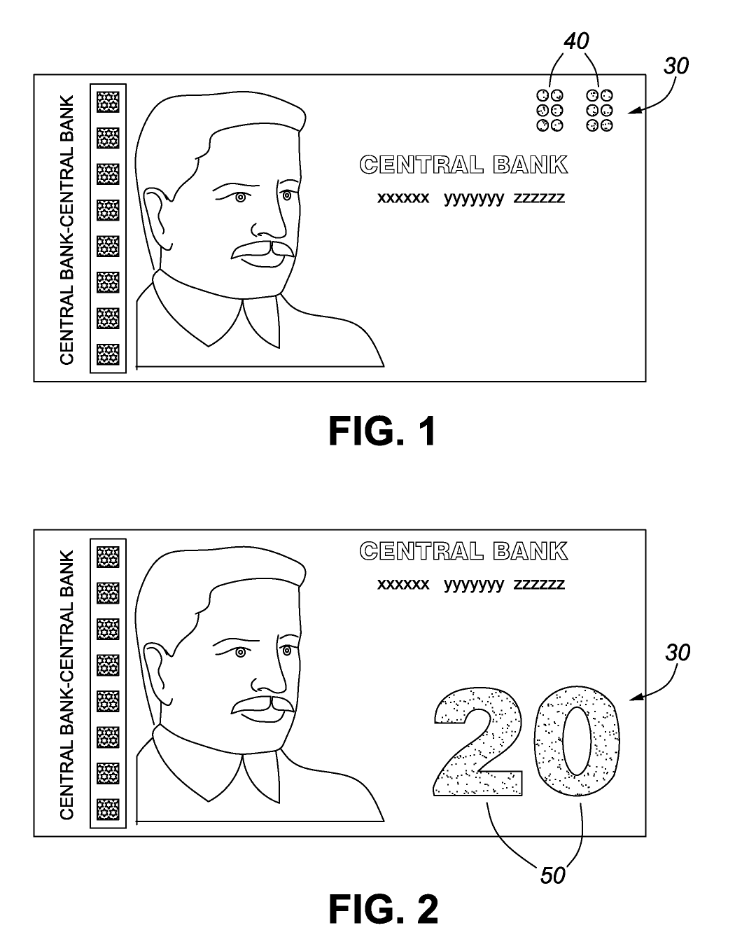

The constituents used for the compositions were prepared on a 200 g scale, and were mixed using magnetic stirring bars. Screen printing was done manually using a 40-mesh screen to print a tactile feature comprising a pattern of six dots as per the embodiment shown by FIG. 1; the same screen was used for all of the tested compositions. UV-curing was carried out on a laboratory UV-curing unit “KTI-Print”, using one pass, with the speed of “100 units” on the scale. Cured samples were cut to the standard square shape for durability testing using a crumpling test. The crumpling test consisted of eight dry crumples and was carried out using the NBS Testing Device for Crumple Testing of Banknotes (manufactured by IGT Testing Systems). The crumpled samples were evaluated visually, under 30× magnification, using a standard stereoscopic microscope. A new rigorous durability rating was established and assigned to each test sample based on a rating scale from RO to R9. Under this more rigorous test rating scheme a rating of R0-R5 was considered poor to low durability, R6 was considered borderline but acceptable and R7-R9 was considered good to best durability. The rating was done taking into consideration the following: any part of the printed tactile feature which was lost, cracks, and the presence of any broken-out areas.

The results of these tests showed that the compositions comprising high concentrations of a trifunctional acid ester (SR-9053), namely, the identified test samples comprising 60 wt % and 80 wt % thereof, provided substantially better durability than the composition of applicant's parent application Ser. No. 13/131,781. The test results are presented in Table 3 below.

TABLE 3

| | Composition: | | |
|---|---|---|---|
| | | Per Table 2 - | Per Table 2 - |
| | | with 60 wt % | with 85 wt % |
| | Per Table 1 | SR-9095 | SR-9095 |
| Durability Rating: R0-R9 | R4 | R8 | R7 |
| Comments | Some loss of | Tactile dots | Most tactile |
| | tactile dots, | largely remain, | dots remain, |
| | parts of dots | some cracks | some cracks |
| | broken-off | | |

In addition, a separate production bench test confirmed an increase in resistance to delamination on bending the substrate with the bending angle of 90 degrees. This bench test was used to predict the durability of the tactile marks in handling, particularly in folding the banknotes by the users for keeping them in wallets. The crumple durability of the samples was rated using samples subjected to eight dry crumples on a standard crumple tester used for banknotes. All samples were exposed to the same treatment (such as screen printing and curing conditions) and differed only in the composition formulations.

The new ultraviolet light (UV)-curable tactile print composition substantially comprises a trifunctional acid ester in the range of about 30-85 wt % of the composition, and preferably in the range of 60-80 wt %. The composition further includes a flexibilizer in the range of about 3-30 wt % and urethane acrylate in the range of about 4-30 wt %. In addition, relatively small amounts of photoinitiator and rheological additives are included and a person skilled in the art will be able to readily identify appropriate amounts of these constituents. As persons skilled in the art will further understand, small amounts of other additives, such as defoamer and pigment (e.g. fluorescent dye), may also be included in the composition. The sample formulations include about 6 wt % of photoinitiator, namely, about 3 wt % of each of Irgacure 2100 and Irgacure 184 manufactured by Ciba. For the rheological additive, about 2 wt % Aerosil 200 by Evonic Industries, a hydrophilic fumed silica, is preferred to reduce the printing-tailing effect often resulting from the relatively high viscosity of the composition. Alternatively, a precipated silica rheological additive could be used instead of Aerosil 200.

The composition of the present invention more preferably comprises a trifunctional acid ester in the range of about 60-80 wt % of the composition, a flexibilizer in the range of about 3-9 wt % and urethane acrylate in the range of about 4-28 wt %.

The flexibilizer used for the tested new compositions of Table 2 is the product CN 131 by Sartomer, which has an elongation parameter of about 200 and is a low viscosity aromatic monoacrylate oligomer that produces strong yet flexible free radically cured films. Alternative flexibilizer compounds which may be used are UV-curable acrylates having an elongation parameter within a range of 100 to 400.

The present composition was printed onto a paper banknote substrate 20 to produce tactile features 30 in the form of a pattern of discrete marks 40 consisting of dots (per FIG. 1). Alternatively, for another application, the tactile marks 40 could be shaped as bars, ovals, stars, triangles or other shape. In another embodiment, the present composition was printed onto a paper banknote substrate 20 to produce tactile features 30 in the form of larger continuous tactile graphical patterns 50 (per FIG. 2). The composition used for the example of FIG. 1 is transparent or highly translucent so that the printed tactile marks 40 produced on the exemplary banknotes are non-obtrusive to established designs printed on them. However, this characteristic is not necessary and, for some applications, may not be desired or adopted. The security document substrate sheet is preferably paper but the compositions of the present invention may also be used on a polymer substrate for an alternative embodiment.

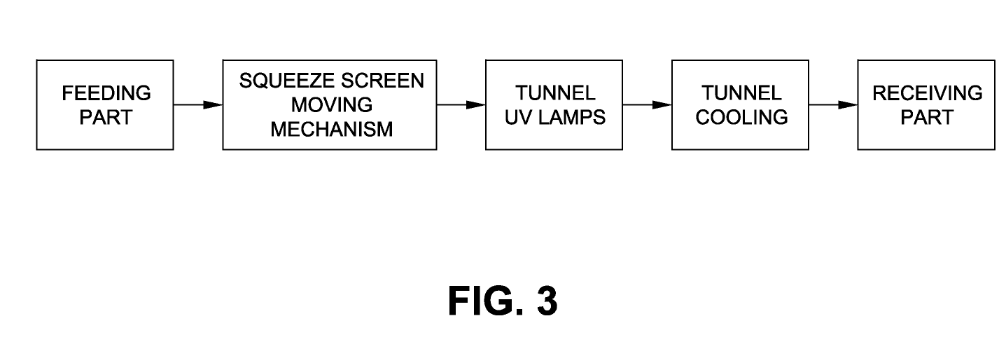

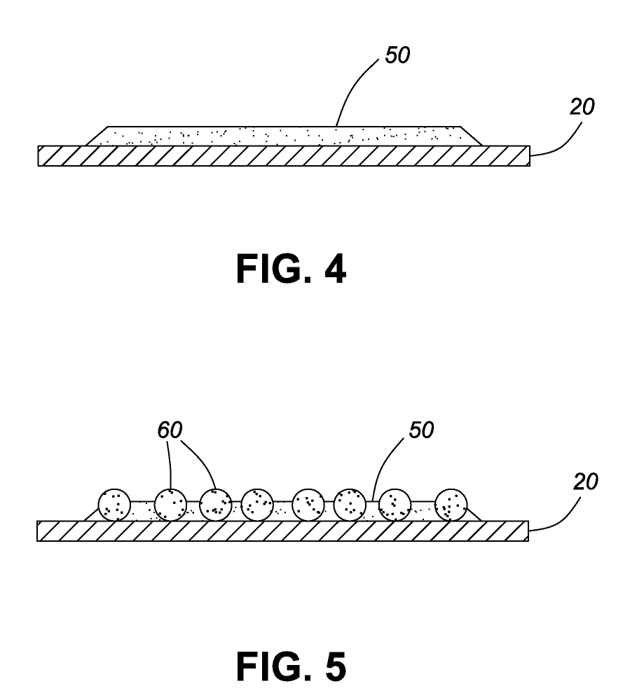

The present composition is printed onto a security document (e.g. banknote) substrate by a conventional (well known) screen printing method according to FIG. 3. Once the composition has been printed it is cured by exposure to ultraviolet (UV) light to form a tactile feature 30 which may be easily felt and discerned, so as to distinguish that type or character of security document by a person who is visually impaired. The length of time of exposure of the substrate to the deposit composition, after printing and before curing, will affect the degree of penetration of the deposit composition into the substrate, with a longer exposure time resulting in increased penetration.

The formulation of the composition of the present invention was found to be particularly suitable for printing tactile features in the form of relatively large continuous graphical patterns 50 as shown by FIG. 2, having widths and lengths in the range of about 5-25 mm and heights (i.e. thicknesses) of about 50 to 150 micrometers as compared with the sets of smaller discrete tactile marks 40 in the form of dots, as shown by FIG. 1, having diameters of about 1 mm or less (more specifically, in the range of 0.1 to 5mm) and heights of about 60 to 120 micrometers. For printing the continuous graphical patterns 50 it was found that the cured composition should not be rigid because, if rigid, the printed large shapes would crack and parts of the shapes would break off when the banknote is further processed and printed.

In one embodiment, an appropriate amount of a grit component 60, namely, microspheres of poly(methylmethacrylate), was added to the curable print composition in an amount of about 5 parts of grit per 100 parts of the composition, and the mixture of grit and composition was printed to form a continuous graphical pattern 50 as shown by FIG. 5. The option to add grit, up to about 60 parts of grit to 100 parts of composition, is to establish a rough texture on the surface of the tactile feature 30 i.e. the graphical pattern 50 in FIG. 5. Although the foregoing grit component was chosen for the illustrated embodiment, one skilled in the art will readily understand that various other constituents may, alternatively, be used for this purpose, for example, microspheres of polystyrene or hollow glass microspheres. The use of spherical-shaped grit, such as microspheres, is preferred for screen printing because the microspheres do not clog the screens.

Various exemplary embodiments have been disclosed by the foregoing and are to be considered as illustrative only, not restrictive or limiting of the scope of the invention. It is to be understood by the reader that various changes and modifications can be made while still making use of the invention, which is defined by the appended claims, and without departing from the scope thereof. All variations and equivalents coming within the meaning of the appended claims are intended to be embraced within the scope of the present invention.

What is claimed is:

1. A method for making a tactile feature for use by the visually impaired on a substrate of a security document, comprising:
(a) printing an ultraviolet light curable printable composition onto the substrate in a predetermined pattern, wherein the composition substantially comprises an acidic trifunctional acrylate ester; and,
(b) exposing the printed composition to ultraviolet light to cure the printed composition and form the tactile feature on the substrate;
wherein the tactile feature has an easy-to-feel tactility to enable a person who is visually impaired to distinguish the security document.

2. The method of claim 1 wherein the composition comprises an amount of 30-85 wt % of acidic trifunctional acrylate ester.

3. The method of claim 2 wherein the composition comprises an amount of 60-80 wt % of acidic trifunctional acrylate ester.

4. The method of claim 1 wherein the composition comprises effective amounts of flexibilizer, urethane acrylate, photoinitiator and a rheological additive.

5. The method of claim 3 wherein the composition comprises a flexibilizer in the range of about 3-9 wt % and urethane acrylate in the range of about 4-28 wt %, and effective amounts of photoinitiator and a rheological additive.

6. The method of claim 5 wherein the flexibilizer is a low viscosity monoacrylate having an elongation parameter within a range of 100 to 400.

7. The method of claim 6 wherein the rheological additive is silica.

8. The method of claim 7 wherein the tactile feature comprises a continuous graphical pattern having a width and length in the range of 5 to 50 mm.

9. The method of claim 8 wherein the tactile feature comprises a pattern of discrete marks in the form of dots having a diameter of 1 mm or less, or bars, ovals, stars or other shape having a width and length in the range of 0.1 to 5 mm.

10. A method for making a tactile feature on a security document, comprising:
(a) printing an ultraviolet light curable composition onto a substrate of the security document in a predetermined pattern, wherein the composition comprises:
(i) 30-85 wt % of a trifunctional acid ester;
(ii) 3-30 wt % of a flexibilizer;
(iii) 4-30 w t% of urethane acrylate;
(iv) photoinitiator in an effective amount to cure the composition by exposure to ultraviolet light; and,
(v) a rheological additive in an effective amount for thixotropy control;
(b) exposing the printed composition to ultraviolet light to cure the printed composition and form the tactile feature on the substrate;
wherein the tactile feature has an easy-to-feel tactility enabling a person who is visually impaired to distinguish the security document.

11. The method of claim 10 wherein the composition comprises a mixture of:
(i) about 60-80 wt % of a trifunctional acid ester;
(ii) about 3-9 wt % of a flexibilizer;
(iii) about 4-28 wt % of urethane acrylate;
(iv) about 8 wt % photoinitiator; and,
(v) about 2 wt % rheological additive.

12. The method of claim 11 wherein the tactile feature comprises a continuous graphical pattern.

13. The method of claim 11 wherein the flexibilizer is a low viscosity monoacrylate having an elongation parameter within a range of 100 to 400.

14. The method of claim 13 wherein the rheological additive is silica.

15. The method of claim 12 wherein the continuous graphical pattern has a width and length in the range of 5 to 50 mm.
